(19) United States
(12) Patent Application Publication
(10) Pub. No.: US 2012/0316922 A1
(43) Pub. Date: Dec. 13, 2012

(54) METHOD AND SYSTEM FOR CREATING SIMILARITY-BASED OVERLAY NETWORK OF MICRO-MARKETS

(75) Inventors: Ramses Morales, Webster, NY (US); Yu-An Sun, Webster, NY (US)

(73) Assignee: Xerox Corporation, Norwalk, CT (US)

(21) Appl. No.: 13/158,860

(22) Filed: Jun. 13, 2011

(51) Int. Cl. G06Q 10/00

(52) U.S. Cl. 705/7.33

(57) ABSTRACT

A method and system for creating a similarity-based overlay network of micro-markets. One or more distributed micro-markets can be operatively connected via a self-organizing overlay network to exchange data between distributed micro-markets in the network. A market similarity function can be computed by applying a filtering function with respect to a network protocol that is defined over particular attributes in order to enable decentralized clustering of similar markets. The data can be further advertised with respect to a set of neighbor markets in order to avoid selfish and rational behaviors between the markets. Such an approach dynamically evolves a structure of the micro-markets over time in order to optimize a desired market interaction in the network.

### TECHNICAL FIELD

Embodiments are generally related to distributed micro-markets. Embodiments are also related to self-organizing overlay networks. Embodiments are additionally related to the creation of an overlay network of micro-markets.

### BACKGROUND OF THE INVENTION

Micro-markets are distributed host systems that operate as isolated sites within a network environment (e.g., the Internet). Such micro-market sites can be employed for designing, creating, and manufacturing products, marketing strategies, and/or advertising campaigns with respect to a specific segment of a user's access to a micro-market system. Data such as, for example, job-positing data (e.g., a customer request for proposal (RFP) and/or a bid with respect to a particular marketing site) can be only viewed by a particular user (e.g., a RFP creator and a bidder) who has access or belongs to that particular marketing site. Users belonging to other marketing sites, however, are unable to access and view the data (e.g., job positing data) of that particular marketing site.

A self-organizing overlay network can be created with respect to the micro-markets for communicating and exchanging data (e.g., job-positing data) between users of different sites in the network. Such self-organizing overlay networks typically enable users of the multiple micro-markets to learn about, for example, relevant job-postings created in other market environments. An overlay network also provides an opportunity for users to interact across the network and increase the revenue of both the users and marketers in the network.

Prior art self-organizing overlay networks do not directly address the features herein to allow interaction between previously isolated micro-markets. Such prior art overlay networks are not designed to allow micro-markets to effectively share data (e.g., job-posting data) with respect to a broad array of evolving customer needs. In order to effectively compute and share data within the network environment, micro-markets will require additional infrastructure. Furthermore, markets in the overlay network may misbehave by adding undesired job-postings in order to “spam” a competitor market, or may decide not to follow the protocol in other “selfish” ways.

Based on forgoing, it is believed that a need exists for an improved system and method for creating a similarity-based overlay network of micro-markets in order to effectively exchange data between evolving distributed micro-markets, as described in greater detail herein.

### BRIEF SUMMARY

The following summary is provided to facilitate an understanding of some of the innovative features unique to the disclosed embodiments and is not intended to be a full description. A full appreciation of the various aspects of the embodiments disclosed herein can be gained by taking the entire specification, claims, drawings, and abstract as a whole.

It is, therefore, one aspect of the disclosed embodiments to provide for an improved networked micro-market system and method.

It is another aspect of the disclosed embodiments to provide for an improved system and method for creating a similarity-based overlay network that targets micro-market needs.

It is further aspect of the present invention to provide for an improved method for exchanging data (e.g. job-positing data and/or other types of data) between the distributed micro-markets in the overlay network.

The aforementioned aspects and other objectives and advantages can now be achieved as described herein. A system and method for creating a similarity-based overlay network of micro-markets is disclosed herein. One or more distributed micro-markets can be operatively connected via a self-organizing overlay network (e.g., a form of a peer-to-peer network) in order to exchange data between the distributed micro-markets in the network. A market similarity function can be computed by applying a filtering function (e.g., a Bloom filter, such as a Tanimoto Coefficient comparing Bloom filter) with respect to one or more attributes, such as, for example, a skill set (e.g., a job-posting skill set and/or a bidder skill set) in order to enable decentralized clustering of similar markets using, for example, a well-defined network protocol. Data such as job-postings, for example, can be further advertised with respect to a set of neighbor markets while dealing with selfish and rational behaviors between markets. Such an approach dynamically evolves a structure over time in order to optimize a desired market interaction in the network. The similarity-based overlay maintains a number of neighbor lists, one for each market attribute that needs to be utilized to cluster similar markets together.

The market similarity function can be computed based on a correlation of market characteristics between, for example, pairs of micro-markets (e.g., the skill set). The sets of overlay-neighbor markets such as, job posting neighbors, bidder-neighbors, and long-link neighbors can be generated based on the market similarity function. The set of neighbors can be stored into a directory (e.g., in a memory) of the micro-market (e.g., a simple “in memory” database. The number of elements of an attribute (e.g. skill sets) used for computing the market similarity function can be limited via a moving time window in order to avoid computation and performance based issues within the micro-market network, and to allow evolution of the neighbor sets as markets change over time. The time span covered by the moving time window can be represented as a unit of time (T). Such an approach can provide a flexible platform to effectively exchange data while-ensuring scalability and fault tolerance with respect to the micro-markets.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a schematic view of a system that includes an overlay network management module, an operating system, a user interface, and a micro-market software application in accordance with the disclosed embodiments;

FIG. 2 illustrates a graphical representation of a networked micro-market system being a member of a similarity-based overlay network, in accordance with the disclosed embodiments;

FIG. 3 illustrates a block diagram of a networked micro-market system, in accordance with the disclosed embodiments; and

FIG. 4 illustrates a high level flow chart of operations illustrating logical operational steps of a method for creating the similarity-based overlay network of micro-markets in order to efficiently exchange data in the network, in accordance with the disclosed embodiments.

### DETAILED DESCRIPTION

The embodiments now will be described more fully hereinafter with reference to the accompanying drawings, in which illustrative embodiments of the invention are shown. The embodiments disclosed herein can be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, the present invention can be embodied as a method, data processing system, or computer program product. Accordingly, the present invention may take the form of an entirely hardware embodiment, an entirely software embodiment or an embodiment combining software and hardware aspects all generally referred to herein as a “circuit” or “module.” Furthermore, the present invention may take the form of a computer program product on a computer-usable storage medium having computer-usable program code embodied in the medium. Any suitable computer readable medium may be utilized including hard disks, USB Flash Drives, DVDs, CD-ROMs, optical storage devices, magnetic storage devices, etc.

Computer program code for carrying out operations of the present invention may be written in an object oriented programming language (e.g., Java, C++, etc.) The computer program code, however, for carrying out operations of the present invention may also be written in conventional procedural programming languages, such as the “C” programming language or in a visually oriented programming environment, such as, for example, VisualBasic.

The program code may execute entirely on the user's computer, partly on the user's computer, as a stand-alone software package, partly on the user's computer and partly on a remote computer or entirely on the remote computer. In the latter scenario, the remote computer may be connected to a user's computer through a local area network (LAN) or a wide area network (WAN), wireless data network e.g., WiFi, Wimax, 802.xx, and cellular network or the connection may be made to an external computer via most third party supported networks (for example, through the Internet using an Internet Service Provider).

The invention is described in part below with reference to flowchart illustrations and/or block diagrams of methods, systems, and computer program products and data structures according to embodiments of the invention. It will be understood that each block of the illustrations, and combinations of blocks, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the block or blocks.

Although not required, the disclosed embodiments will be described in the general context of computer-executable instructions, such as program modules, being executed by a single computer. In most instances, a “module” constitutes a software application. Generally, program modules include, but are not limited to routines, subroutines, software applications, programs, objects, components, data structures, etc., that perform particular tasks or implement particular abstract data types and instructions. Moreover, those skilled in the art will appreciate that the disclosed method and system may be practiced with other computer system configurations, such as, for example, hand-held devices, multi-processor systems, data networks, microprocessor-based or programmable consumer electronics, networked PCs, minicomputers, mainframe computers, servers, and the like.

Note that the term module as utilized herein may refer to a collection of routines and data structures that perform a particular task or implements a particular abstract data type. Modules may be composed of two parts: an interface, which lists the constants, data types, variable, and routines that can be accessed by other modules or routines, and an implementation, which is typically private (accessible only to that module) and which includes source code that actually implements the routines in the module. The term module may also simply refer to an application, such as a computer program designed to assist in the performance of a specific task, such as word processing, accounting, inventory management, etc.

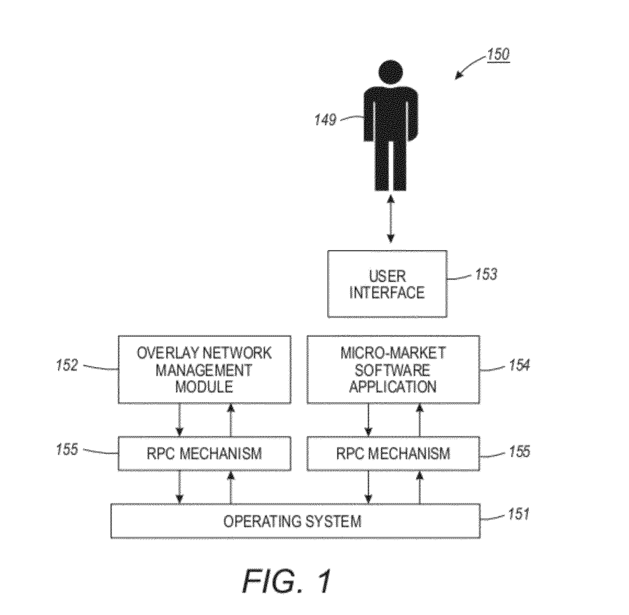

Referring now to FIG. 1, a system 150 is illustrated, which includes an overlay network management module 152, an operating system 151, a micro-market software application 154 and a user interface 153 with respect to a user 149, in accordance with the disclosed embodiments. Note that the micro-market software application 154 can be stored in a memory of, for example a data-processing apparatus (not shown in FIG. 1). System 150 thus includes a kernel or operating system 151 and a shell or interface 153 and one or more application programs, such as the micro-market software application 154.

In general, the operating system 151 can be composed of programs (e.g., modules) and data that run on computers or other data-processing devices or systems, and which manages the computer hardware and provides common services for efficient execution of various application software, such as, for example, the micro-market software application 154 and/or the overlay network management module 152. For hardware functions such as input and output and memory allocation, the operating system 151 can function as an intermediary between application programs and the computer hardware, although in most embodiments, the application code is usually executed directly by the hardware, but will frequently call the operating system 151 or be interrupted by it.

Note that the overlay network management module is not required to be directly on top of the same operating system 151 as the micro-market software application 153. That is, the overlay network management module 152 can reside in a different host and can communicate utilizing an RPC (Remote Procedure Call) mechanism 155. It is important, however, that such components are located generally within the same LAN (Local Area network). Note that the RPC mechanism 155 implements a Remote Procedure Call, which is an inter-process communication that allows a computer program to cause a subroutine or procedure to execute in another address space (commonly on another computer on a shared network) without the programmer explicitly coding the details for this remote interaction. That is, the programmer writes essentially the same code whether the subroutine is local to the executing program, or remote. When the software in question uses object-oriented principles, for example, RPC may be referred to as remote invocation or a remote method invocation.

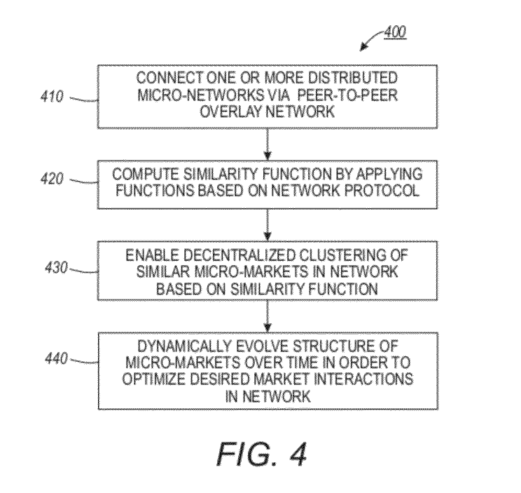

The interface 153, which is preferably a GUI (Graphical User Interface), can serve to display results, whereupon a user may supply additional inputs or terminate a particular session. The micro-market software application 154 is generally associated with the overlay network management module 152 for creating a similarity-based overlay network of micro-markets in order to efficiently exchange data between users of different micro-markets. The overlay network management module 152 can include instructions, such as those of method 400 discussed herein with respect to FIG. 4.

FIG. 1 is thus intended as an example, and not as an architectural limitation of the disclosed embodiments. Such embodiments, however, are not limited to any particular application or any particular computing or data-processing environment. Instead, those skilled in the art will appreciate that the disclosed system and method may be advantageously applied to a variety of system and application software. Moreover, the present invention may be embodied on a variety of different computing platforms, including Macintosh, UNIX, LINUX, and the like.

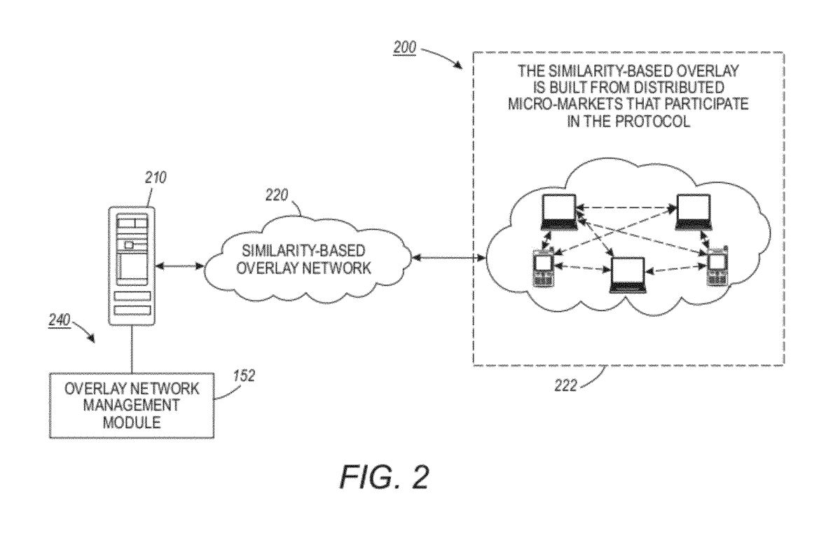

FIG. 2 illustrates a graphical representation of a networked micro-market system 200 being a member of a similarity-based overlay network 220, in accordance with the disclosed embodiments. Note that in FIGS. 1-4 identical parts or elements are generally indicated by identical reference numerals. The networked micro-market system 200 generally includes one or more distributed micro-markets 240, wherein each of the market(s) 240 includes a management server 210 configured with the overlay network management module 152. The management server 210 can communicate with the similarity-based overlay network 220, which in turn can communicate with other distributed markets indicated in FIG. 2 by block 222. Note that block 222 indicates that the similarity-based overlay network is built from distributed markets that participate in the disclosed protocol. The distributed micro-market(s) can be connected via the self-organizing overlay network 220, which is a form of a peer-to-peer (P2P) connection technology in order to exchange data (e.g., job-posting data) between the distributed micro-markets 240 in the network 220.

The management server 210 along with the overlay network management module 152 effectively manages and ensures the communication between the distributed micro-markets 240, thus building the overlay network 220. The overlay network management module 152 can also be configured to advertise customer data with respect to relevant micro-markets 240 in order to avoid selfish and rational behaviors between the markets 240. The similarity-based overlay network 220 effectively ensures scalability and fault tolerance with respect to the users of the micro-markets 240. The overlay network 220 is designed in a completely distributed and decentralized manner in order to provide a flexible platform to effectively exchange the customer data with respect to a broad array of evolving market characteristics.

The networked micro-market system 200 is the Internet with the similarity-based overlay network 220 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, networked micro-market system 200 also may be implemented as a number of different types of networks, such as for example, an intranet, a local area network (LAN), or a wide area network (WAN). Note that the configuration depicted in FIG. 2 is intended as an example, and is not an architectural limitation with respect to different embodiments of the present invention.

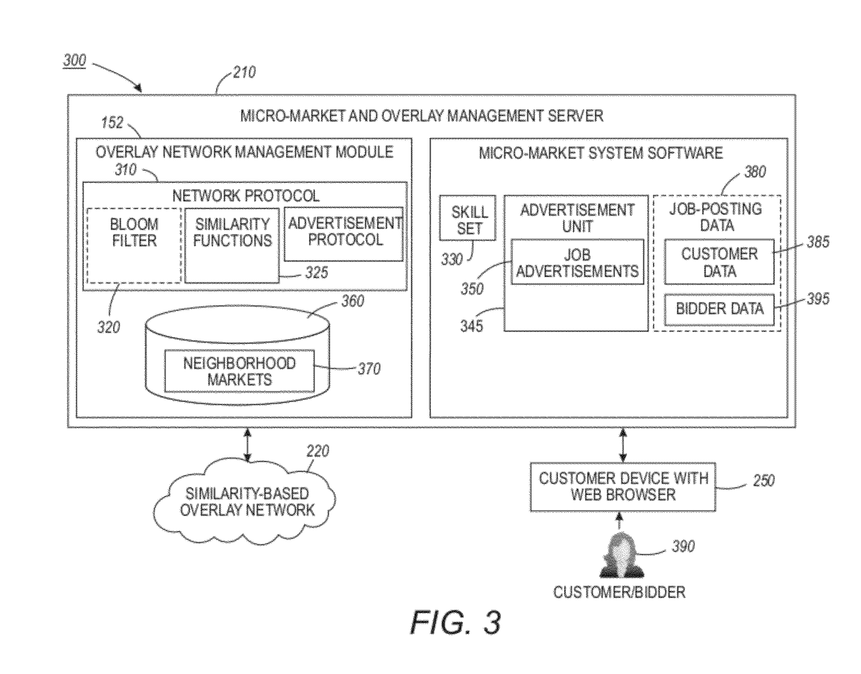

FIG. 3 illustrates a block diagram of a networked micro-market system 300, in accordance with the disclosed embodiments. In general, the networked micro-market system 300 includes server 210, which can function as a micro-market and overlay network management server. Note that the server 210 shown in FIG. 3 is analogous to the management server 210 depicted in FIG. 2, although it can be appreciated that such servers may vary from one another, depending upon design considerations.

The overlay network management module 152 is associated with the network management sever 210 and generally includes a network protocol 310 implemented with a bloom filter 320. Note that the bloom filter 320 is a data structure that allows for memory efficient and computationally fast set membership-tests. The network protocol 310 can further include an advertisement protocol 340 and similarity functions 325. The overlay network management module 152 can also include a database 360, which includes data indicative of neighbor markets. Server 210 can also run micro-market system software 328, which can be composed of, for example, modules such as a skill set module 330, an advertisement unit or module 345 and job posting data 380.

As indicated in FIG. 3, a customer device 250 can communicate with the server 210. The customer device 250 of the micro-market(s) 240 can provide, for example, remote data 380, which can include, for example, customer RFP (Request For Proposal) data 385 and/or bidder data 395, in order to communicate the data 380 between user(s) 390 within the network 220. The user 390 with respect to the customer device 250 can be, for example, a customer and/or a bidder of the micro-market 240. Note that the customer device 250 can be, for example, a computing device such a wireless PDA (Personal Digital Assistant), Smartphone, personal computer, laptop computer, or other types of computing devices such as a computer server, and so forth.

The similarity-based overlay network 220 can be configured as a powerful abstraction that creates a virtual network of connected devices layered on an existing underlying network in order to provide new network functionality. Such overlay networks 220 may be employed to construct content services networks in a wide range of networking applications. The overlay network 220 also ensures trust, integrity and security of the data transmitted between the nodes. Note that the nodes in the overlay network 220 can be, for example, a single micro-market.

The server 210 further computes a market similarity function 325 with respect to the distributed micro-markets 240 over a skill set 330 in order to enable decentralized clustering of similar markets. Note that the skill set 330 disclosed herein can be such as, for example, a job-posting skill set and/or a bidder skill set. The market similarity function 325 can be computed by correlating, for example, the attributes 330 (e.g., skill sets) of the data 380 (e.g., job-posting data) with respect to the micro-markets 240 in the network 220. The market similarity function 325 can be also computed based on a market characteristic such as, payments and market age characteristics.

The similarity function 325 with respect to a given skill set 330 that is posted by the customer data 385 can be represented as follows:

f:S_{RFP}(Mᵢ)×S_{RFP}(Mⱼ)→[0,1] (1)

Where, S_{RFP} (Mᵢ) represents the skill sets 330 listed in the customer data 385 on the market i and S_{RFP} (Mⱼ) represents the skill sets 330 listed in the customer data 385 on the market j. The similarity function 325 can be computed as a real number between 0 and 1 that reflects the similarity in the markets i and j. The similarity function 325 with respect to the skill sets 330 that is posted by the bidder data 395 can be represented as follows:

g:S_{bidders}(Mᵢ)×S_{bidders}(Mⱼ)→[0,1] (2)

Where, S_{bidders} (Mᵢ) represents the skill sets 330 by the bidders 390 on the market i and S_{bidders} (Mⱼ) represents the skill sets 330 advertised by the bidders 390 on the market j. The similarity function 325 can be computed as a real number between 0 and 1 that reflects the similarity in the markets i and j.

The network management server 210 further generates a set of neighbors 370 with respect to each market 240 in the network 220 based on the market similarity function 325. The set of neighbors 370 with respect to the micro-market 240 can be such as, a job-posting neighbor, a bidder neighbor and a long-link neighbor. The set of neighbors 370 can be stored into a low traffic directory database 360 of the server 210. Note that each neighbor set can include O(log(N)) elements, where N represents the number of markets in the overlay network. It is a well-known result from random graphs theory that if each node has O(log(N)) randomly created edges, then the graph will be connected.

The skill set 330 for computing the market similarity function 325 can be limited via a moving timing window in order to avoid computation and performance based issues within the networked micro-market system 200. The skill set 330 shown in FIG. 3, however, is not used in its entirety when computing the market similarity function 325. Instead, only those skills whose dates fall within a moving time window are utilized, thereby avoiding computation and performance based issues. Note that the time span covered by the timing window can be represented as a unit of time (T), which is a system parameter shared by all the overlay network management modules 152 in the overlay network 220.

The bloom filter 320 implemented with the network protocol 310 can be represented as a fixed size bit array with m bits. An element into the array of bloom filter 320 can be inserted by applying k hash functions to the element causing k specific bits to be set in the bit array. To determine if a particular skill listed in market A also exists in market B, the k hash functions can be applied to the skill, and if the resulting bits are set on B's bit array, then A and B have that skill in common. The probability p that there is a false positive when using Bloom filters to test set membership is a function of m and k. To achieve a particular p, m can be set as follows (i.e., see equation (3) below):

m=−n·ln(p)/ln(2)² (3)

Where, n represents the size of the universe of elements. The optimal value for k, to achieve p can be represented as follows:

K=ln(2)·m/n (4)

For example, if the universe of possible skills in the markets is n=10⁶ elements, and a false positive rate of p=0.01 is desired, then the bloom filter 320 can be represented as, for example, m=9585058 bits, and utilize, for example, k=7 hash functions. Note that equations (3) and (4) above are well-known results from literature.

The network protocol 310 of the micro-market system 200 periodically re-computes the bloom filter 320 for each time period (T) in each market. The system 200 further traverses the set of neighbors 370. During the traversal of the job-posting neighbors and bid neighbors, the system 200 pulls the current Bloom filter 220 of each neighbor 370, and computes the similarity functions f and g by comparing the Bloom filter to each pulled Bloom filter. Such comparisons can be performed utilizing the similarity function 325 that can be represented as a cosine similarity function or a tanimoto co-efficient as follows:

A·B/∥A∥·∥B∥ (5)

∥A·B∥2/∥A∥+∥B∥−∥A·B∥² (6)

Where, A and B represents the bit arrays of the bloom filter 320 of the local market i and the peer market j. The similarity function 325 can also be computed by raw comparisons of the fraction of the intersection of the set bits. The resulting value can be further compared to a threshold value (τε[0, 1]), which is generally a system-wide parameter. If the similarity function 325 is greater than the threshold value (τ), the neighbor 370 can remain in the respective list; otherwise, the neighbor 370 can be removed from the list as it is deemed to be not similar.

It is important to maintain the size of the lists in θ(log(N)). Therefore, if any neighbor was removed from RFP-neighbors or Bid-neighbors, and there are nodes added to the temporary neighbor list, then the available slots in the neighbor lists will be repopulated by the nodes in the temporary neighbor list. If nodes were removed, but the temporary neighbor list is empty, then a random walk is initiated every T/4, sending log(N) messages to the overlay using the current links in the three lists, to find new potential neighbors. Nodes that are contacted by the random walk will reply with their current Bloom Filter, to allow computation of f and g as explained above. The random walk will be limited by a T T L=c·log(N)—if after a random walk there remain available slots in the RFP-neighbors or Bid-neighbors list, then c can be incremented to explore a larger portion of the overlay. Any node found not to be similar during this random walk can be utilized to populate available slots in the long-links list.

The micro-market i typically join the overlay network 220 by contacting an arbitrary market j that is already present in the overlay network 220. The arbitrary market j forwards a join request to a random selection of log(N) neighbors 370. The forwarded message can include a time-to-live (TTL)-log(N) 370, and each neighbor receiving the join request forwards it to one randomly selected neighbor 370.

The advertising unit 340 of the networked micro-market system 200 further generates job advertisements 350 of the job-posting data 380 with respect to the relevant micro-markets 240. The job-posting data 380 can be proactively advertised into the market and transmitted to the set of neighbors 370 based on the limitations provided by the neighbor market j. The neighbor market j further receives the job-posting data (nⁱ_{ad}) 380 within a time span t_{ad}. Similarly, the system 200 proactively permits the bidder 390 to learn about the job-posting data 380 that are relevant, but are placed in other markets 240 in the network 220.

A new bidder may receive a suggestion along with the job-posting data 380 with respect to the markets 240 in order to select the set of neighbors 370 for a particular market i. The job-posting data 380 are also posted on the other markets 240 that are relevant to the bidder 390 in the market i. Providing appropriate cost rewards for the markets 240 advertising the job-postings 380 with respect to the competitor markets can therefore eliminate the selfish-behaviors and collusions between the micro-markets 240. The selfish and rational behaviors in the network 220 include, flooding of job-postings, generating SPAM from the valid and/or colluding neighbors 370.

Additionally to the previous mechanism, we need to address the issue of spam from valid neighbors—we say that a valid neighbor is sending spam when it repeatedly sends the same RFP, or when it sends more RFPs than what the receiver is interested in accepting. To address this SPAM, each incoming link at node i will have a value associated to it, Nj/t, that determines the number of RFPs that i is willing to accept from j within a time RFP window t. Node i can communicate this value to market j when the incoming link is created at i; then j, assuming it behaves, will use this values to determine what are the best RFPs to send to i, i.e., the RFPs that are more likely to win a bid at i (this decision is better left to the people running the market). If j sends more than Nj/t, node i will ignore them, RFP and could potentially stop interacting with j.

In addition to the previous selfish behaviors, markets can potentially collude to flood RFPs. Consider market i, j, and l. Market j and l are colluding to improve the propagation of their RFPs, and market i is a well-behaving market. Moreover, market j appears in i's incoming links—i.e., they are similar according to function f—but market l does not. Market j could take some RFPs from 1 and send them to market i as if they belonged to j. We want to avoid this behavior as it would decrease the utility of the RFP advertising feature, from the point of view of the people bidding in i, i.e., the relevance of the advertised RFPs would not be as high as expected.

To avoid this kind of SPAM we need some extra assumptions. There will be a trusted third party providing cryptographic keypairs to RFP creators, e.g., Xerox. Moreover, each market will have a cryptographic keypair, and their public key will be accessible through the trusted third party. When an RFP is created, its creator will cryptographically sign it. The signature will be computed using the content of the RFP, and the content of the market's public key. Whenever an RFP is routed through the overlay, it will include the signature, the creator's public key, and the signature of the creator's public key (signed by the trusted third party). After an RFP is received, the public key of the creator will be verified using the trusted third party's public key. If that verification is OK, then the signature of the RFP will be verified using the creator's public key, and with knowledge of the originating market's public key (which can be obtained from the trusted third party)—it is expected that this public key is the key of the market that sent the RFP. By doing this verification, market j will not be able to forward an RFP from 1 to i, because i will know that the RFP did not originate at j.

The similarity-based overlay network 220 also maintains a number of neighbor lists, one for each market attribute that needs to be utilized to cluster similar markets together. If a particular market i, for example, wants to transmit a message to another market similar to itself with regards to attribute A, then i can consult its A-neighbor list, maintained by the similarity overlay. The single attribute routing of any message will always take one hop, unless there are no markets similar to i on the desired attribute.

FIG. 4 illustrates a high level flow chart of operations illustrating logical operational steps of a method 400 for creating the similarity-based overlay network of micro-markets 200 in order to efficiently exchange data in the network 220, in accordance with the disclosed embodiments. Note that the method 400 can be implemented in the context of a computer-useable medium that contains a program product, including, for example, a module or group of modules. The distributed micro-markets 240 can be operatively connected via the self-organizing overlay network 220 in order to exchange the job-posting data 380 between the users 390 of different micro-markets 240 in the network 220, as illustrated at block 410.

The market similarity function 325 can be computed by applying a filtering function via the bloom filter 320 based on the network protocol 310. That is, such a function can be applied to different attributes stored in a micro-market database. In one scenario, the network protocol 310 can be defined over the skill set 330. However, the embodiments are not limited to skills. Again, such functions can be applied to varying attributes. The similar markets 240 in the network 220 can be further clustered in the decentralized manner based on the market similarity function 325, as illustrated at block 430. The structure of the micro-markets 240 can be dynamically evolved over time in order to optimize desired market interactions in the network 220, as illustrated at block 450. The networked micro-market system with the similarity-based self-organizing network effectively ensures data exchange between the distributed micro-markets within the network.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method, comprising:
connecting a plurality of distributed micro-markets via an overlay network in order to communicate and exchange data between distributed micro-markets among said plurality of distributed micro-markets in said overlay network;
computing a market similarity with respect to said plurality of distributed micro-markets by applying a filtering function based on a network protocol defined over at least one attribute in order to enable decentralized clustering of said plurality of distributed micro-markets; and
advertising said data with respect to a set of neighbor markets in said overlay network in order to avoid selfish behaviors and collusions between said distributed micro-markets among said plurality of distributed micro-markets and thereby dynamically evolve a structure of said plurality of distributed micro-markets over time and optimize a market interaction in said overlay network.

2. The method of claim 1 further comprising configuring said data as job-posting data.

3. The method of claim 1 further comprising computing said market similarity function by correlating said at least one attribute with respect to said plurality of distributed micro-markets.

4. The method of claim 1 further comprising computing said market similarity function based on characteristics of said plurality of distributed micro-markets.

5. The method of claim 1 further comprising:
generating said set of neighbor markets with respect to said plurality of distributed micro-markets based on said market similarity function; and
storing said set of neighbor markets into a general-purpose database.

6. The method of claim 1 further comprising limiting said at least one attribute for computing said market similarity function via a moving timing window in order to avoid computation and performance based issues within said overlay network.

7. The method of claim 6 further comprising representing a time span covered by said moving timing window utilizing a unit of time.

8. The method of claim 1 wherein said filtering function comprises a Bloom filter.

9. The method of claim 1 further comprising connecting said plurality of distributed micro-markets utilizing a peer-to-peer connection technology.

10. A system, comprising:
a processor;
a data bus coupled to said processor; and
a computer-usable medium embodying computer code, said computer-usable medium being coupled to said data bus, said computer program code comprising instructions executable by said processor and configured for:
connecting a plurality of distributed micro-markets via an overlay network in order to communicate and exchange data between distributed micro-markets among said plurality of distributed micro-markets in said overlay network;
computing a market similarity with respect to said plurality of distributed micro-markets by applying a filtering function based on a network protocol defined over at least one attribute in order to enable decentralized clustering of said plurality of distributed micro-markets; and
advertising said data with respect to a set of neighbor markets in said overlay network in order to avoid selfish behaviors and collusions between said distributed micro-markets among said plurality of distributed micro-markets and thereby dynamically evolve a structure of said plurality of distributed micro-markets over time and optimize a market interaction in said overlay network.

11. The system of claim 10 wherein said data comprises job-posting data.

12. The system of claim 10 wherein said instructions are further configured for computing said market similarity function by correlating said at least one attribute with respect to said plurality of distributed micro-markets.

13. The system of claim 10 wherein said instructions are further configured for computing said market similarity function based on characteristics of said plurality of distributed micro-markets.

14. The system of claim 10 wherein said instructions are further configured for:
generating said set of neighbor markets with respect to said plurality of distributed micro-markets based on said market similarity function; and
storing said set of neighbor markets into a general-purpose database.

15. The system of claim 10 wherein said instructions are further configured for limiting said at least one attribute for computing said market similarity function via a moving timing window in order to avoid computation and performance based issues within said overlay network.

16. The system of claim 10 wherein said filtering function comprises a Bloom filter.

17. The system of claim 10 wherein said instructions are further configured for connecting said plurality of distributed micro-markets utilizing a peer-to-peer connection technology.

18. A computer-usable for, said computer-usable medium embodying computer program code, said computer program code comprising computer executable instructions configured for:
connecting a plurality of distributed micro-markets via an overlay network in order to communicate and exchange data between distributed micro-markets among said plurality of distributed micro-markets in said overlay network;
computing a market similarity with respect to said plurality of distributed micro-markets by applying a filtering function based on a network protocol defined over at least one attribute in order to enable decentralized clustering of said plurality of distributed micro-markets; and
advertising said data with respect to a set of neighbor markets in said overlay network in order to avoid selfish behaviors and collusions between said distributed micro-markets among said plurality of distributed micro-markets and thereby dynamically evolve a structure of said plurality of distributed micro-markets over time and optimize a market interaction in said overlay network.

19. The computer usable medium of claim 18 wherein said embodied computer program code further comprises computer executable instructions configured for computing said market similarity function by correlating said at least one attribute with respect to said plurality of distributed micro-markets.

20. The computer usable medium of claim 18 wherein said embodied computer program code further comprises computer executable instructions configured for computing said market similarity function based on characteristics of said plurality of distributed micro-markets.
